(19) United States
(12) Patent Application Publication
(10) Pub. No.: US 2006/0160527 A1
(43) Pub. Date: Jul. 20, 2006

(54) Methods and devices for broadcasting and accessing a service offer specific to a geographical area in a wireless telecommunications network

(75) Inventors: Fabrice Tran Xuan, Eybens (FR); Eric Villain, Saint Martin D' Heres (FR); Henri Teyssier, Saint Nazaire Les Eymes (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 11/334,026

(22) Filed: Jan. 18, 2006

(30) Foreign Application Priority Data
Jan. 18, 2005 (FR) 0500494

(51) Int. Cl. H04Q 7/38

(52) U.S. Cl. 455/414.1

(57) ABSTRACT

Service areas are defined in a wireless telecommunications network, each area being defined by the addresses of fixed stations for accessing the network situated in that area. The access devices to those services obtain the file defining the areas and a file defining the services in the areas from a peer-to-peer network. They determine the area in which they are located from the address of the fixed station by which they are connected to the wireless network.

### BACKGROUND OF THE INVENTION

The general field of the present invention is that of broadcasting service offers specific to a geographical area containing communicating terminals.

This concept of local services, which is also known as service provisioning, enables a service offer to appear spontaneously on a terminal according to its location, any change of location being liable to lead to the appearance of a different offer.

The present invention may be used in a local network, i.e. in any type of geographically defined network in which specific services may be implemented.

### PRIOR ART

The company Appear Networks offers a system for automatically presenting applications to a wireless terminal user as a function of the user's location.

The Appear Networks system is based on dividing the wireless telecommunications network into service areas, each of which is associated with a multicast address.

In the Appear Networks system, each service area is serviced by a set of radio units, each of which must be configured beforehand in order to filter out all multicast addresses circulating on the network except for those of its area. This configuration operation is at the very least tedious, in particular when the system is used on a site whose layout varies frequently (for example an exhibition center).

Another system offered by Appear Networks divides the site into areas on the basis of site calibration measurements.

To be more precise, the power of radio signals received from wireless telecommunications network access stations is measured regularly and correlated with a map of the site.

An application installed on the communicating terminals determines the position of the user and therefore the service area in which the user is located.

The above system has the drawback that the calibration method is not reliable over time, as it is very easily disturbed by a change to the environment (addition or removal of partitions, the presence of a crowd, etc.).

### OBJECTS AND SUMMARY OF THE INVENTION

The present invention aims to alleviate the above-mentioned drawbacks. To this end, a first aspect of the invention provides a device for accessing, via a wireless telecommunications network, services delivered in service areas covered by said network, the device comprising:
means for obtaining a file defining said service areas, a service area being defined in the file by a list of the addresses of fixed stations for accessing the network situated in said area;
wireless communications means adapted to obtain periodically the address of the fixed station connecting said device to said wireless telecommunications network;
means for determining the area in which said device is currently being used from said area file and from said address of said connection station;
means for obtaining a file defining the services offered in said area; and
means for presenting said services to a user of said device.

The invention provides a related method of accessing services delivered in service areas covered by a wireless telecommunications network, which method can be used by the above access device and comprises:
a step of obtaining a file defining said service areas, a service area being defined in that file by a list of the addresses of fixed stations for accessing the network situated in said area;
a step of obtaining the address of the fixed station connecting said access device to said wireless telecommunications network;
a step of determining the area in which said device is currently being used from said area file and from said address of said connection station;
a step of obtaining a file defining the services offered in said area; and
a step of presenting said services to a user of said device.

Thus location of the access device of the invention is based on the knowledge of the unique address (MAC address) of the fixed station of the wireless network through which it is connected, a service area being defined by the addresses of the fixed stations situated in that area.

Thus it is not necessary to reconfigure the fixed access stations when the layout of the wireless network is modified.

Moreover, no calibration phase is necessary.

A second aspect of the invention provides a device for managing an offer of services delivered in service areas covered by a wireless telecommunications network, terminals connected to said wireless telecommunications network belonging to a peer-to-peer network, the device comprising:
means for storing a file defining said service areas, a service area being defined in that file by a list of the addresses of fixed stations for accessing the wireless communications network situated in said area;
means for storing a file defining the services offered in said areas; and
means for making said files available to peers of said peer-to-peer network.

The invention also provides a related method of managing an offer of services delivered in service areas covered by a wireless telecommunications network, terminals connected to said wireless telecommunications network belonging to a peer-to-peer network, the method comprising:
a step of storing a file defining said service areas, a service area being defined in that file by a list of the addresses of fixed stations for accessing the wireless telecommunications network situated in said area;
a step of storing a file defining the services offered in said areas; and
a step during which said files are made available to peers of said peer-to-peer network.

According to this aspect of the invention, the management device advantageously makes these files available to the peers by exploiting the sharing service intrinsic to the peer-to-peer network.

A peer-to-peer network is one in which each station (called a “peer”) has equivalent capacities and responsibilities. This concept therefore differs from a client/server architecture in which a few stations serve the others. All the peers can also organize themselves into groups of peers, communicate with each other, and publish and discover network resources (notification channels).

In this embodiment, the access device referred to above subscribes to the peer-to-peer network as a client peer and obtains the files of areas and services from a peer of that network.

To be more precise, the management device of the invention is preferably adapted to accept a subscription request from a client peer in the network and, in response to that request, to send a reference for obtaining the file of areas from a peer of the network.

The files of areas and services may in particular be compressed to economize on bandwidth in the wireless telecommunications network.

The files preferably conform to the XML format enabling a structural representation of the service offer, for example in accordance with topics.

Each service, or each service topic, may be associated with an icon in the service definition file, and these icons may be displayed to the user of the access device.

In a preferred embodiment, the steps of the access method and the management method are determined by instructions of computer programs.

Consequently, the invention also provides a computer program on an information medium which can be executed in an access device, the program including instructions adapted to execute an access method as referred to above.

The invention also provides a computer program on an information medium which can be executed in a service offer management device, the program including instructions adapted to execute a management method as referred to above.

The above computer programs may use any programming language and be in the form of source code, object code or an intermediate code between source code and object code, such as in a partially compiled form, or in another desirable form.

The invention is also directed to an information medium that can be read by a device that can be used as a peer in a peer-to-peer network and contains instructions of one or more computer programs such as those referred to above.

The information medium may be any entity or device capable of storing the program. For example, the medium may comprise a storage medium, such as a ROM, for example a CD-ROM or a microelectronic circuit ROM, or magnetic storage means, for example a diskette (floppy disk) or a hard disk.

Moreover, the information medium may be a transmissible medium such as an electrical or optical signal, which may be routed via an electrical or optical cable, by radio or by other means. The program of the invention may in particular be downloaded over an Internet-type network.

Alternatively, the information medium may be an integrated circuit into which the program is incorporated and which is adapted to execute the method in question or to be used in the execution thereof.

### BRIEF DESCRIPTION OF THE DRAWINGS

Other features and advantages of the present invention emerge from the following description with reference to the appended drawings, which show an embodiment of the invention that is in no way limiting on the invention. In the figures:

FIG. 1 is a diagram of a wireless telecommunications network encompassing an access device and a service offer management device both conforming to a preferred embodiment of the invention;

FIG. 2 shows an area file that may be used in the invention;

FIG. 3 is a flowchart of the main steps of an access method of a preferred embodiment of the invention; and

FIG. 4 is a flowchart of the main steps of a preferred embodiment of a method of the invention of managing a service offer.

### MORE DETAILED DESCRIPTION

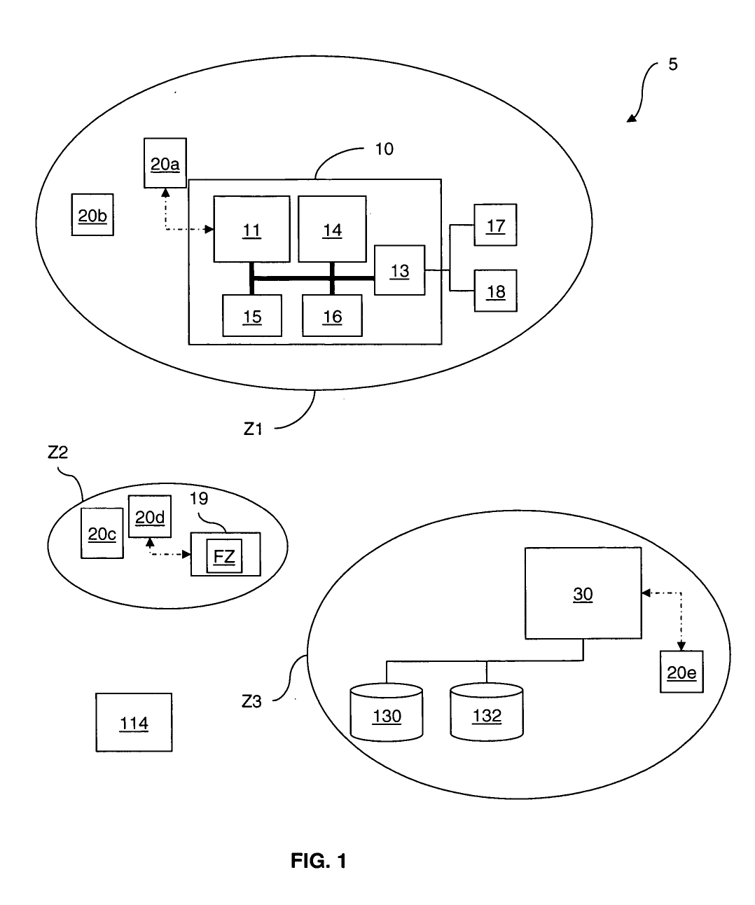

FIG. 1 represents a wireless telecommunications network 5 that is divided into three geographical areas Z1, Z2, Z3.

According to the invention, each geographical area is defined by a list of the addresses of fixed stations for accessing the wireless telecommunications network 5 situated in that area. FIG. 1 shows stations 20a to 20e for accessing the wireless telecommunications network 5. By convention, ADi denotes the MAC address of the access station 20i.

The MAC address is a unique identifier for each access station; this is known in the art; it is also the identifier by means of which a terminal can tell to which station it is connected at any given time (it is then known as a basic service set identifier (BSSID)).

Thus the MAC addresses are grouped to form service areas Z1, Z2, Z3, and knowing its BSSID enables a terminal to tell the service area in which it is located.

Accordingly, referring again to FIG. 1:
the area Z1 is defined by the addresses ADa, ADb of the fixed stations 20a, 20b in that area,
the area Z2 is defined by the addresses ADc, ADd of the fixed stations 20c, 20d in that area, and
the area Z3 is defined by the address ADe of the fixed station 20e in that area.

The reference 10 denotes an access device that conforms to a preferred embodiment of the invention.

The access device 10 includes a processor 14, wireless telecommunications means 11, a read-only memory 15, a random-access memory 16, a keypad 17, and a screen 18, the latter two items being controlled by the processor 14 via an input/output module 13.

In accordance with the invention, the access device 10 includes means for determining the area in which it is located.

To this end, it obtains firstly the address ADa of the station 20a through which it is connected to the wireless telecommunications network 5. That address may typically be obtained by a driver controlling the module 11 for wireless telecommunication with that station.

The driver may be controlled by the processor 14 of the access device 10, for example.

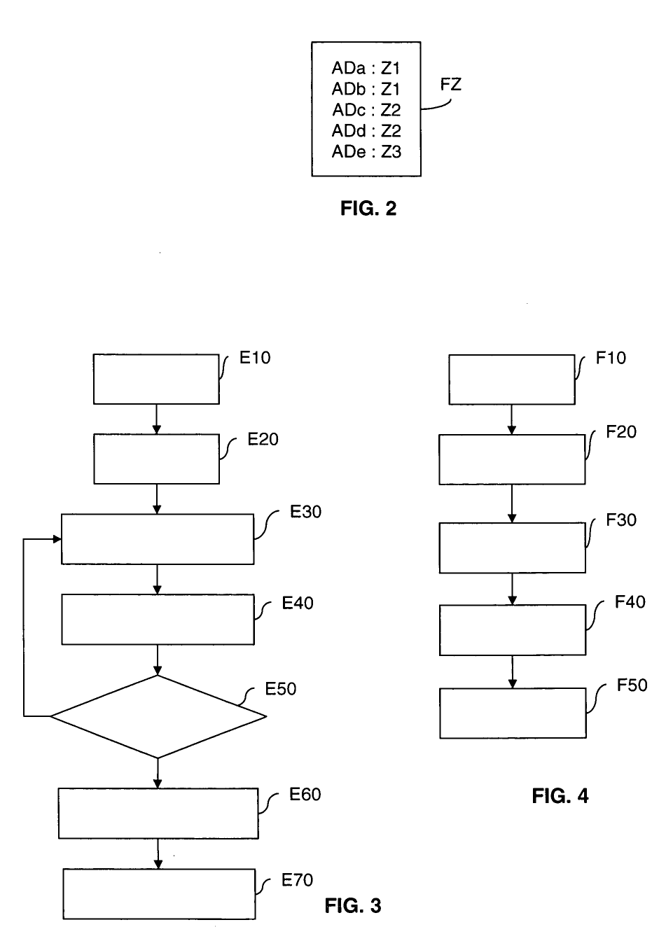

The access device 10 of the wireless telecommunications module 11 obtains a file FZ that defines the service areas covered by the wireless telecommunications network 5. FIG. 2 shows a file of this kind and gives the addresses of the stations that provide access to the network 5 situated in each service area Z1, Z2, Z3.

On finding in the area file FZ the address ADa of the station 20a through which it is connected, the access device 10 determines that it is in the service area Z1.

FIG. 1 also shows a service offer management device 30 of the invention.

One task of the device 30 is to generate the area file FZ described above with reference to FIG. 2.

In the present preferred embodiment, the area file FZ is stored beforehand in a database 130 by an administrator using a terminal 114 which includes, for example, means for reading a map of the site on which the wireless telecommunications network 5 is installed and means for converting that map into the SVG format known in the art.

Before this, each site is associated with a map and a scale. The site is then divided into service areas each associated with a map and a scale and with a particular network configuration. The access stations 20i servicing each area are then known and this information is sufficient to create the above-mentioned area file FZ.

The terminal 114 also defines the services available in each of the areas Z1, Z2, Z3. For example, the terminal 114 provides an interface for displaying all the available services in a first window and the services constituting an offer in a second window. The service data is then stored in a database 132 accessible to the offer management device 30.

The access device 10 obtains the service definition file using its wireless telecommunications module 11.

In the present preferred embodiment, the access device 10, a terminal 19 and the management device 30 are peers of a peer-to-peer network.

To be more precise, the management device 30 is a server peer in that network. When the management device 30 logs onto the peer-to-peer network, it uses the content sharing service of the network to make the area file FZ and the services file available to all the peers 10, 19, 30 of the peer-to-peer network.

In the FIG. 1 example, it is assumed that the management device 30 has ascertained that the file FZ has been made available to the other peers of the network by the peer 11 of the area Z2.

The infrastructure makes the files to be shared available by signaling to the peer-to-peer network that a new resource (file) identified by a given name is available. Any peer starting a search based on that name has access to the content indexed by the platform.

When the access device 10 wishes to access the peer-to-peer network, it uses a communications channel to subscribe to the management peer 30. On receiving this subscription request, the management peer 30 communicates a reference to the access device 10 so that it may obtain the area file FZ.

In the present example, that reference is the address of the peer 19 that hosts the data file FZ.

When the access device 10 receives the area file FZ for the first time, or when it detects a change of area (from a change of the address of the fixed station through which it is connected), it solicits the file sharing service of the peer-to-peer network to obtain the service offer file for that area.

On receiving that file, the access device 10 shows the services available in the area Z1 in which it is located.

In practice, it displays on the screen 17 of the access device 10 icons representing those services, the icons being contained in the service definition file.

FIG. 3 shows the main steps E10 to E70 of an access method of a preferred embodiment of the invention.

During a first step E10, an access device 10 of the invention sends a request to subscribe to a peer-to-peer network.

This subscription step E10 is followed by a step E20 during which it receives, in response to the subscription request, a reference for obtaining an area file FZ available on the peer-to-peer network.

The access device 10 then obtains the area file FZ during the same step E20. The area file defines the service areas covered by the wireless telecommunications network, each area being defined by the list of the addresses of the fixed network access stations.

This step E20 is followed by a step E30 during which the access device 10 obtains the address ADa of the fixed station 20a through which it is attached to the wireless telecommunications network.

This step of obtaining an address is followed by a step E40 during which it determines the area in which it is currently located from the area file FZ obtained in the step E20 and the address ADa obtained in the step E30.

This is determined by reading the identifier of the area associated with the address ADa in the area file FZ directly, as described above with reference to FIG. 2.

The determination step E40 is followed by a test E50 during which the access device 10 verifies whether it has changed area or not. The result of this test E50 is positive if the access device has just changed area, i.e. if the address of the connection station obtained in the step E30 is associated with a new area, or at the time of the first use of the access device in the network.

When the above is not the case, the result of the test E50 is negative. The test is then followed by the step E30 already described of obtaining the address of the fixed connection station of the access device 10.

Thus the steps E30 to E50 constitute a loop for detecting a change of area.

When a change of area is detected, the test E50 is followed by a step E60 during which the access device 10 obtains a service file made available on the peer-to-peer network.

As already described, that service file lists the services available via the wireless communications network in the area in which the access device 10 is currently being used.

This step E60 for obtaining the service file is followed by a step E70 during which the access device 10 presents said services to the user of the device.

This presentation step consists in displaying on the screen 18 of the access device 10 icons representing services available in that area, for example.

In the preferred embodiment described here, the area file FZ and the service file are obtained from a peer of the peer-to-peer network. Of course, the two files may be obtained from different peers.

As described above, these two files are made available over the peer-to-peer network by a management device 30 of the invention using a management method described next with reference to FIG. 4, which represents the main steps F10 to F50 of the method.

During a first step F10, the service offer management device 30 stores the area file FZ in a database 130.

That step F10 is followed by a step F20 during which the management device 30 stores the file defining the services in the various areas in the same database 130.

Those files may in particular be created by an administrator using the terminal 114.

During a step F30, the access management device 10 makes the two files available to the peers of the peer-to-peer network.

This step of making the files available is known in the art of peer-to-peer networks and will not be described here.

When, during a step F40, the access device 30 receives a subscription request from a client peer, it responds, during a step F50, by sending a reference enabling that client to obtain the area file FZ over the peer-to-peer network. In the example described here, that reference is the address of the peer 19 storing the area file FZ.

What is claimed is:

1. A device for accessing, via a wireless telecommunications network, services delivered in service areas covered by said network, the device comprising:
means for obtaining a file defining said service areas, a service area being defined in the file by a list of the addresses of fixed stations for accessing the network situated in said area;
wireless communications means adapted to obtain periodically the address of the fixed station connecting said device to said wireless telecommunications network;
means for determining the area in which said device is currently being used from said area file and from said address of said connection station;
means for obtaining a file defining the services offered in said area; and
means for presenting said services to a user of said device.

2. The accessing device according to claim 1, wherein terminals connected to said wireless telecommunications network constitute a peer-to-peer network, the device including means for subscribing as a client peer in said peer-to-peer network and the means for obtaining said area file and said service file are adapted to obtain said files from peers of said peer-to-peer network.

3. A device for managing an offer of services delivered in service areas covered by a wireless telecommunications network, terminals connected to said wireless telecommunications network belonging to a peer-to-peer network, the device comprising:
means for storing a file defining said service areas, a service area being defined in that file by a list of the addresses of fixed stations for accessing the wireless communications network situated in said area;
means for storing a file defining the services offered in said areas; and
means for making said files available to peers of said peer-to-peer network.

4. The managing device according to claim 3, constituting a server peer in said peer-to-peer network and including:
means for receiving a subscription request from a client peer in said peer-to-peer network, and
means for sending said client peer, in response to said request, a reference for obtaining said area file from a peer of said peer-to-peer network.

5. A method of accessing services delivered in service areas covered by a wireless telecommunications network, which method can be used by an access device according to claim 1 and comprises:
a step of obtaining a file defining said service areas, a service area being defined in that file by a list of the addresses of fixed stations for accessing the network situated in said area;
a step of obtaining the address of the fixed station connecting said access device to said wireless telecommunications network;
a step of determining the area in which said device is currently being used from said area file and from said address of said connection station;
a step of obtaining a file defining the services offered in said area; and
a step of presenting said services to a user of said device.

6. The accessing method according to claim 5, including a step of said client device subscribing as a client peer in a peer-to-peer network comprising a plurality of terminals connected to said wireless telecommunications network and said steps of obtaining said area files and service files enable said files to be obtained from peers of said peer-to-peer network.

7. A computer program on an information medium, said computer program being executable by the accessing device according to claim 1, wherein the program contains instructions adapted to execute an access method comprising:
a step of obtaining a file defining said service areas, a service area being defined in that file by a list of the addresses of fixed stations for accessing the network situated in said area;
a step of obtaining the address of the fixed station connecting said access device to said wireless telecommunications network;
a step of determining the area in which said device is currently being used from said area file and from said address of said connection station;
a step of obtaining a file defining the services offered in said area; and
a step of presenting said services to a user of said device.

8. An information medium readable by accessing the device according to claim 1, wherein the medium contains instructions of a computer program adapted to execute an access method comprising:
a step of obtaining a file defining said service areas, a service area being defined in that file by a list of the addresses of fixed stations for accessing the network situated in said area;
a step of obtaining the address of the fixed station connecting said access device to said wireless telecommunications network;
a step of determining the area in which said device is currently being used from said area file and from said address of said connection station;
a step of obtaining a file defining the services offered in said area; and
a step of presenting said services to a user of said device.

9. A method of managing an offer of services delivered in service areas covered by a wireless telecommunications network, terminals connected to said wireless telecommunications network belonging to a peer-to-peer network, the method comprising:
a step of storing a file defining said service areas, a service area being defined in that file by a list of the addresses of fixed stations for accessing the wireless telecommunications network situated in said area;
a step of storing a file defining the services offered in said areas; and
a step during which said files are made available to peers of said peer-to-peer network.

10. The managing method according to claim 9, adapted to be executed by a server peer in said peer-to-peer network, the method including:
a step of receiving a subscription request from a client peer in said peer-to-peer network, and
a step of sending to said client peer, in response to said request, a reference for obtaining said area file from a peer of said peer-to-peer network.

11. A computer program on an information medium, said program being executable by the managing device according to claim 3, wherein the program contains instructions adapted to execute a managing method comprising:
a step of storing a file defining said service areas, a service area being defined in that file by a list of the addresses of fixed stations for accessing the wireless telecommunications network situated in said area;
a step of storing a file defining the services offered in said areas; and
a step during which said files are made available to peers of said peer-to-peer network.

12. An information medium readable by the managing device according to claim 3, wherein the medium contains instructions of a computer program adapted to execute a managing method comprising:
a step of storing a file defining said service areas, a service area being defined in that file by a list of the addresses of fixed stations for accessing the wireless telecommunications network situated in said area;
a step of storing a file defining the services offered in said areas; and
a step during which said files are made available to peers of said peer-to-peer network.
